(19) United States
(12) Patent Application Publication
(10) Pub. No.: US 2022/0018999 A1
(43) Pub. Date: Jan. 20, 2022

(54) DISPLAY BOARD AND DISPLAY DEVICE

(71) Applicant: KABUSHIKI KAISHA TOKAI RIKA DENKI SEISAKUSHO, Aichi (JP)

(72) Inventor: Atsushi YAMAGUCHI, Aichi (JP)

(73) Assignee: KABUSHIKI KAISHA TOKAI RIKA DENKI SEISAKUSHO, Aichi (JP)

(21) Appl. No.: 17/295,330

(22) PCT Filed: Jul. 10, 2019
(86) PCT No.: PCT/JP2019/027298

§ 371 Date: May 19, 2021

(30) Foreign Application Priority Data
Nov. 26, 2018 (JP) 2018-220323
Feb. 13, 2019 (JP) 2019-023711

(51) Int. Cl. G02B 5/02

(52) U.S. Cl. CPC G02B 5/0263; G02B 5/3025

(57) ABSTRACT

[Object] To switch display while reducing a difference in luminance between regions more.

[Solution] Provided is a display board including a composite region that includes a portion provided with a metal film and a potion provided with no metal film. The portion provided with the metal film or the portion provided with no metal film has a predetermined dispersion pattern. In addition, provided is a display device including: a display board including a composite region that includes a portion provided with a metal film and a potion provided with no metal film, the portion provided with the metal film or the portion provided with no metal film having a predetermined dispersion pattern; and a light source that emits illumination light toward the display board.

### TECHNICAL FIELD

The present invention relates to a display board and a display device.

### BACKGROUND ART

There have been known technologies of switchably displaying different graphics or the like on a same display surface without using a complicated structure such as a display. For example, Patent Literature 1 discloses a display device that switches display using one display board by means of polarization. This display device makes it possible to switchably display two graphics or the like by using a simple structure. The two graphics have display regions that partially overlap each other.

### CITATION LIST

### Patent Literature

Patent Literature 1: JP 2017-194582A

### DISCLOSURE OF INVENTION

### Technical Problem

Here, for example, in the case of controlling switching of display by using two types of illumination light having different polarization directions as described in Patent Literature 1, it is important to consider a difference in luminance between a region that transmits one of the two types of illumination light and a region that transmits the both types of illumination light.

Accordingly, the present invention is made in view of the aforementioned issues, and an object of the present invention is to provide a novel and improved display board and display device that make it possible to switch display while reducing a difference in luminance between regions more.

### Solution to Problem

To solve the above-described problems, according to an aspect of the present invention, there is provided a display board including a composite region that includes a portion provided with a metal film and a potion provided with no metal film The portion provided with the metal film or the portion provided with no metal film has a predetermined dispersion pattern.

In addition, the portion provided with the metal film may be positioned on a tip of a pillar structure, and the pillar structure has a dot-like shape.

In addition, the composite region may include a plurality of small regions including the pillar structures of different formation patterns.

In addition, the pillar structure may have a size capable of absorbing wavelength of a visible light region.

In addition, the display board may further include: a first region that includes the metal film that is striped in a first direction; a second region that includes the metal film that is striped in a second direction, which is perpendicular to the first direction; and a light shielding region that has a surface entirely covered with the metal film.

In addition, to solve the above-described problems, according to another aspect of the present invention, there is provided a display device including: a display board including a composite region that includes a portion provided with a metal film and a potion provided with no metal film, the portion provided with the metal film or the portion provided with no metal film having a predetermined dispersion pattern; and a light source that emits illumination light toward the display board.

### Advantageous Effects of Invention

As described above, according to the present invention, it is possible to switch display while reducing a difference in luminance between regions more.

### BRIEF DESCRIPTION OF DRAWINGS

FIG. 1 is a diagram for describing a structure of a composite region according to an embodiment of the present invention.

FIG. 2 is a diagram illustrating an example of small regions included in the composite region according to the embodiment.

FIG. 3 is a diagram illustrating a flow of processing performed in the case of forming a metal film and then removing a predetermined portion of the metal film according to the embodiment.

FIG. 4 is a diagram illustrating a flow of processing performed in the case of transferring a structure and then forming a metal film according to the embodiment.

FIG. 5 is a diagram illustrating a configuration example of a display device according to the embodiment.

FIG. 6 is a diagram simply illustrating a configuration of a conventional display board that makes it possible to switch display by means of polarization.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

### 1. Embodiment

As described above, there have been known technologies of switchably displaying different graphics or the like on a same display surface without using a complicated structure such as a display. For example, Patent Literature 1 discloses the display device that switches display using one display board by means of polarization.

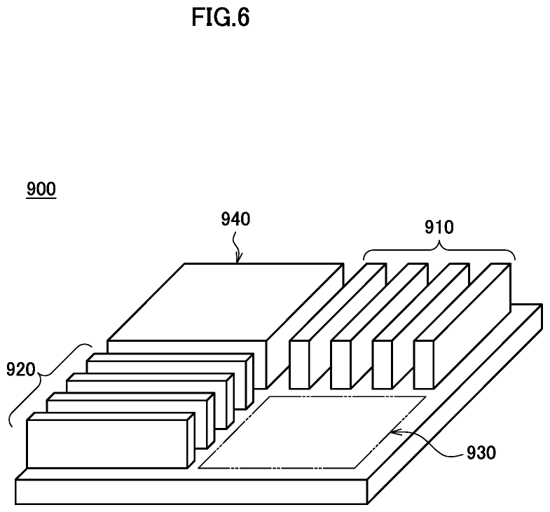

FIG. 6 is a diagram simply illustrating a configuration of a conventional display board that makes it possible to switch display by means of polarization. As illustrated in FIG. 6, for example, a conventional display board 900 includes a first region 910, a second region 920, a composite region 930, and a light shielding region 940.

The first region 910 is a region including a metal film that is striped in a first direction (such as a vertical direction). When the metal film is formed as described above, it is possible to absorb illumination light whose polarization direction is the first direction, and transmit only illumination light whose polarization direction is a second direction (such as a horizontal direction), which is perpendicular to the first direction.

In addition, the second region 920 is a region including a metal film that is striped in the second direction. In contradiction to the first region 910, when the metal film is formed as described above, it is possible to absorb only illumination light whose polarization direction is the second direction, and transmit only illumination light whose polarization direction is the first direction.

In addition, the composite region 930 is a region including no metal film Therefore, the composite region 930 transmits both the illumination light whose polarization direction is the first direction and the illumination light whose polarization direction is the second direction.

In addition, the light shielding region 940 is a region covered with a metal film. In other words, the light shielding region 940 absorbs both the illumination light whose polarization direction is the first direction and the illumination light whose polarization direction is the second direction.

As described above, the conventional display board 900 achieves switchable display of two different graphics or the like by including the four regions, which have different characteristics related to absorption and transmission of two types of illumination light having different polarization directions.

Specifically, in the case where the display board 900 is irradiated with illumination light whose polarization direction is the first direction, the illumination light passes through the second region 920 and the composite region 930 and a first graphic is displayed. On the other hand, in the case where the display board 900 is irradiated with illumination light whose polarization direction is the second direction, the illumination light passes through the first region 910 and the composite region 930 and a second graphic is displayed.

As described above, the conventional display board 900 makes it possible to switchably display the two graphics or the like by using the simple structure. The two graphics have display regions that partially overlap each other. Therefore, for example, when the conventional display board 900 is applied to various kinds of switches installed in vehicles, it is possible to redouble display of graphics or the like related to switches, and allocate two functions to a single switch.

On the other hand, for example, in the case of taking no measure with regard to the structure illustrated in FIG. 6, there may be a difference in luminance between a region that transmits one of the two types of illumination light and a region that transmits the both types of illumination light. Specifically, the composite region 930 that transmits the both types of illumination light has high luminance because the composite region 930 includes no metal film, and the first region 910 and the second region 920, each of which transmits one of the two types of illumination light, has low luminance because the first region 910 and the second region 920 include metal films.

The technical idea of the present invention was conceived by focusing on the above-described points, and makes it possible to achieve switchable display while reducing a difference in luminance between regions. Therefore, a display board 100 according to an embodiment of the present disclosure includes a composite region 130 that includes a portion provided with a metal film and a potion provided with no metal film. In addition, one of features of the composite region 130 is that the portion provided with the metal film or the portion provided with no metal film has a predetermined dispersion pattern.

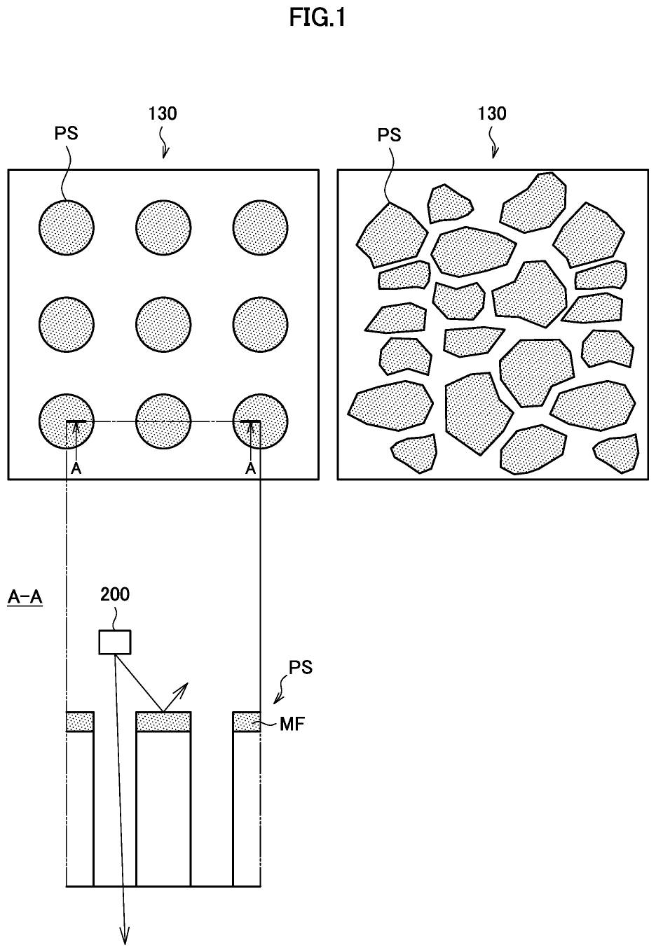

Examples of the dispersion pattern includes various kinds of patterns in which a plurality of structures such as dots are disposed and spaced apart by a predetermined interval, and a pattern in which a plurality of structures having different shapes are randomly disposed. FIG. 1 is a diagram for describing a structure of the composite region 130 according to the present embodiment.

In the case of an example illustrated in FIG. 1, portions provided with metal films MF are formed on tips of pillar structures PS, and the pillar structures PS have a dot-like shape. Note that, the pillar structure PS according to the present embodiment may have a size capable of absorbing wavelength of a visible light region.

Such a configuration allows the metal films MF formed on the tips of the pillar structures PS to reflect or absorb illumination light emitted from a light source 200. On the other hand, the illumination light passes through a portion provided with no pillar structure PS.

Note that, the shape of the pillar structure PS according to the present embodiment is not limited to the dot-like shape (circular shape), but may be any shapes such as various polygonal shapes. In addition, the shapes of the pillar structures PS according to the present embodiment does not have to be unified. The plurality of pillar structures PS may have different shapes.

For example, in the case of the example illustrated in the upper right side of FIG. 1, the plurality of pillar structures PS have respective random shapes, which are different from each other. In addition, the lengths of spaces between the pillar structures PS are random in a similar way.

As described above, the shapes and layout of pillar structures PS according to the present embodiment do not have to have regularity. Even in this case, the metal films MF formed on the tips of the pillar structures PS reflect or absorb illumination light emitted from the light source 200. On the other hand, the illumination light passes through the portion provided with no pillar structure PS.

This makes it possible to reduce the transmittance of the illumination light emitted from the light source 200 to the target value. Therefore, it is possible to effectively reduce a difference in luminance between a first region 110 and a second region 120.

Note that, the first region 110 and the second region 120 according to the present embodiment may have similar structures to the first region and the second region of the conventional display board 900 described above. In other words, the first region 110 according to the present embodiment is a region including a metal film MF that is striped in the first direction, and the second region 120 according to the present embodiment may be a region including a metal film that is striped in the second direction.

Therefore, the pillar structures PS according to the present embodiment may be formed in such a manner that the transmittance of illumination light through the composite region 130 is similar to the transmittance of illumination light through the first region 110 and the second region 120.

For example, the transmittance can be adjusted by adjusting the formation pattern of the pillar structures PS. Examples of the formation pattern includes diameters and shapes of the pillar structures PS, space and pitch between the pillar structures, and the like. In addition, the transmittance can also be adjusted by adjusting the metal film formation patterns of the first region 110 and the second region 120.

The structural example of the composite region 130 according to the present embodiment has been described above. By using the above-described structures of the composite region 03 according to the present embodiment, it is possible to reduce the transmittance of the illumination light through the composite region 130 to the target value. Therefore, it is possible to effectively reduce a difference in luminance between the first region 110 and the second region. This makes it possible to display every portions of graphics or the like with approximately uniform luminance, and it is possible to achieve display with a less feeling of strangeness.

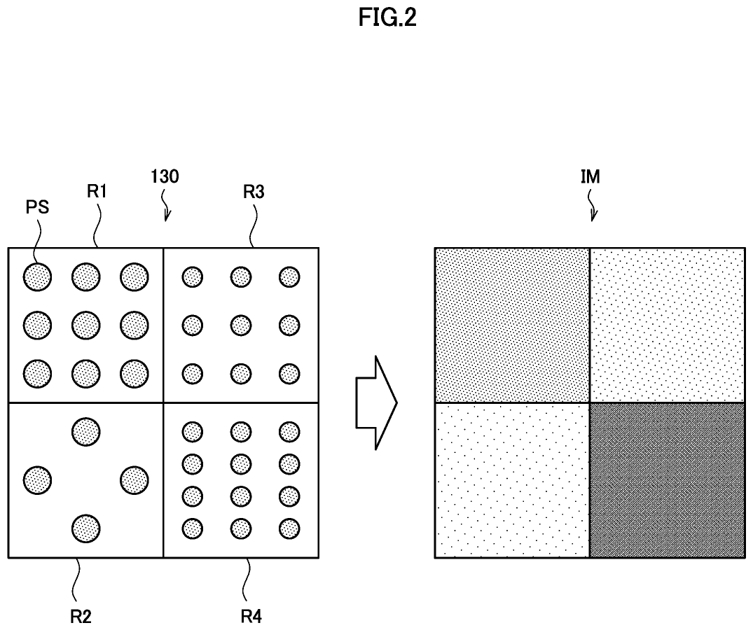

In addition, the composite region 130 according to the present embodiment may include a plurality of small regions including the pillar structures PS of different formation patterns. FIG. 2 is a diagram illustrating an example of the small regions included in the composite region 130 according to the present embodiment.

In the example illustrated in the left side of FIG. 2, the composite region 130 includes four small regions R1 to R4. In addition, here, the four small regions R1 to R4 including the pillar structures PS of different formation patterns.

The above-described structure makes it possible to vary luminance in the composite region 130 as indicated by a transparent image IM in the right side of FIG. 2. This makes it possible to add a shadow to a graphic or the like to be displayed, and it is possible to display more complicated design.

The structural example of the composite region 130 according to the present embodiment has been described above. Note that, with reference to FIG. 1 and FIG. 2, the case where the pillar structures PS provided with the metal films are formed in the dot-like shape has been described above. However, the formation of the metal films in the composite region 130 according to the present embodiment is not limited thereto. For example, the composite region 130 according to the present embodiment may be formed by removing the metal film, which covers the composite region 130, in the dot-like pattern.

Next, a method of manufacturing the display board 100 according to the present embodiment will be described. Examples of the method of manufacturing the display board 100 according to the present embodiment include a method of forming the metal film and then removing a predetermined portion of the metal film through etching or the like, and a method of transferring a structure and then forming the metal film through vapor deposition or the like.

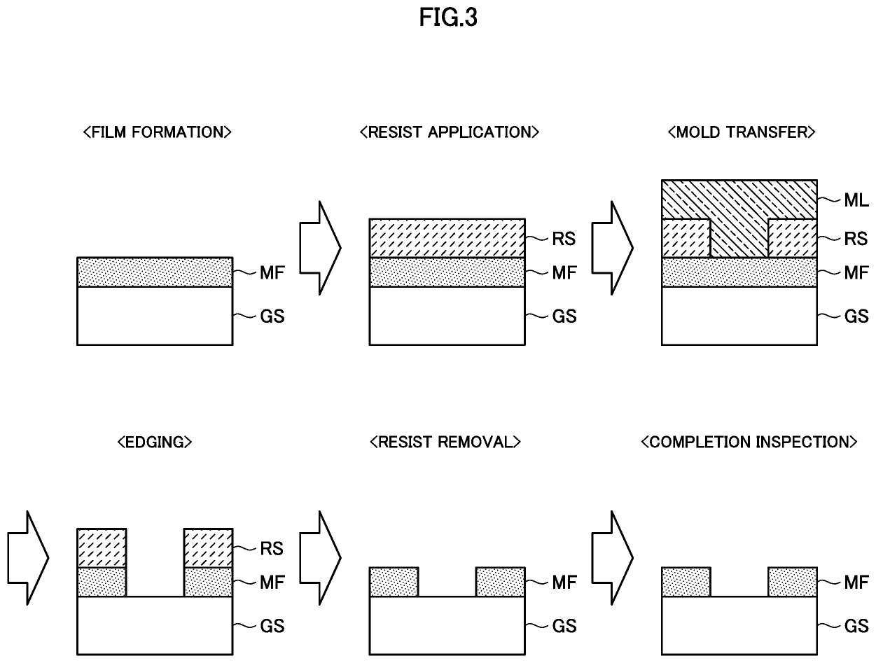

FIG. 3 is a diagram illustrating a flow of processing performed in the case of forming the metal film and then removing a predetermined portion of the metal film In this case, as illustrated in the upper left side of FIG. 3, a metal film MF is formed first on a glass substrate GS by using a film formation device. Note that, for example, material such as aluminum or chromium may be used for the metal film MF.

Next, a resist RS is applied to the formed metal film MF by using a die coater. Resin material is used for the resist RS. In addition, after the application of the resist RS, mold transfer is performed by a nanoimprint device using a mold ML.

Next, etching is performed by a dry etching device to fit a transferred shape of the mold ML, and then the resist RS is removed by a dry cleaning device. Next, a completion inspection is performed by using an image processing device, and a completed display board 100 is obtained.

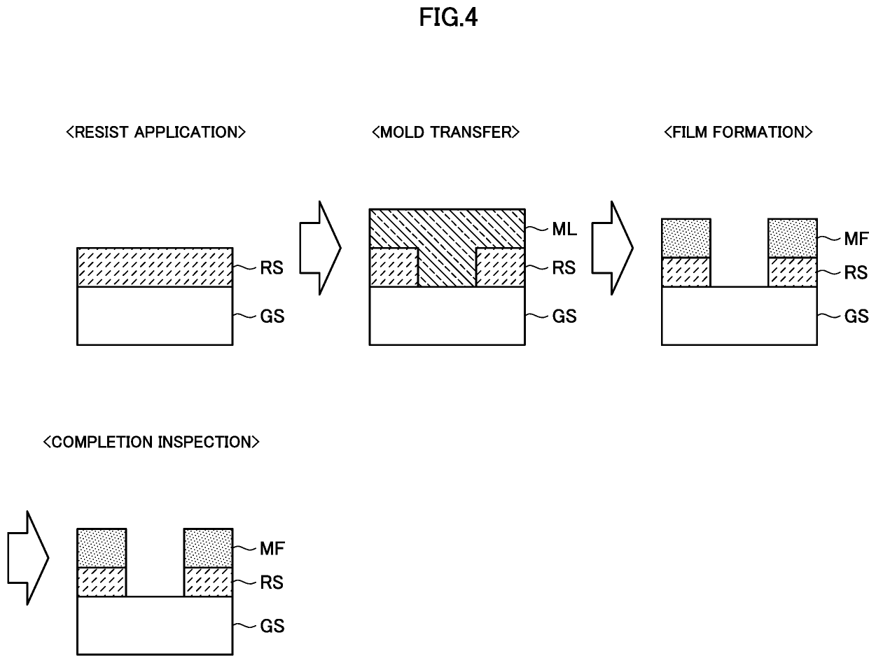

The flow of processing for forming the metal film and then removing a predetermined portion of the metal film has been described above. Next, the method of transferring the structure and then forming the metal film will be described. FIG. 4 is a diagram illustrating a flow of processing performed in the case of transferring a structure and then forming the metal film.

In this case, as illustrated in the upper left side of FIG. 4, the resist RS is first applied to the glass substrate GS by using the die coater. Next, the mold transfer is performed by the nanoimprint device using the mold ML.

Next, the metal film MF is formed through vapor deposition performed by sputtering device, the completion inspection is performed by using the image processing device, and a completed display board 100 is obtained.

The flow of processing according to the method of transferring the structure and then forming the metal film has been described above. By using this method, the metal films are preferentially attached to the tips of the pillar structures PS, and the metal film is less likely to be attached to a bottom, on which the pillar structures PS are not formed. Therefore, for example, it is not necessary to perform a process of covering the bottom with a film formation mask or the like during the vapor deposition, and it is possible to effectively manufacture the display board 100.

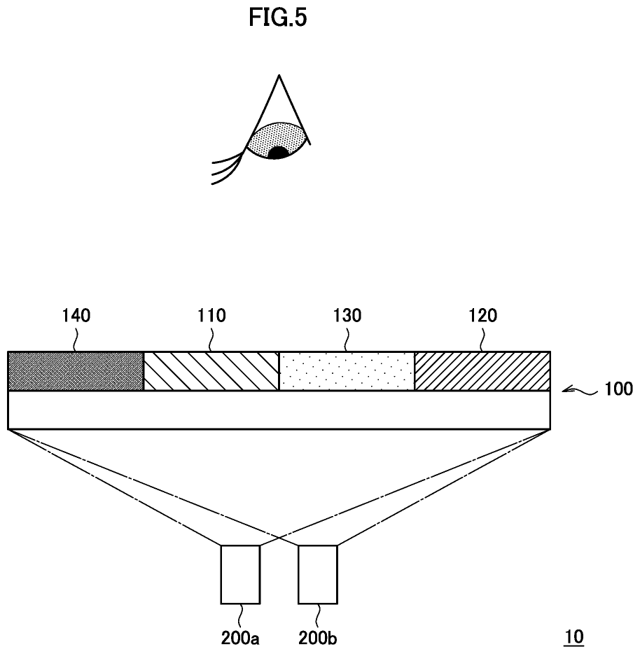

Next, a configuration example of a display device 10 according to the present embodiment will be described. FIG. 5 is a diagram illustrating the configuration example of the display device 10 according to the present embodiment. As illustrated in FIG. 5, the display device 10 according to the present embodiment includes the above described display board 100 and light sources 200a and 200b, which emits illumination light toward the display board 100.

In addition, as illustrated in FIG. 5, the display board 100 according to the present embodiment includes the first region 110, the second region 120, the composite region 130, and a light shielding region 140. Note that, the light shielding region 140 according to the present embodiment may have similar structures to the light shielding region 940 of the conventional display board 900 described above. In other words, the light shielding region 140 according to the present embodiment is a region that is entirely covered with the metal film.

In addition, the light source 200a according to the present embodiment emits illumination light whose polarization direction is the first direction, and the light source 200b according to the present embodiment emits illumination light whose polarization direction is the second direction. For example, the light sources 200a and 200b according to the present embodiment may emit laser light or LED light.

For example, in the case of the laser light, the light sources 200a and 200b adjust the polarization directions in such a manner that each laser light includes a polarization component in a predetermined direction. In addition, for example, in the case of the LED light, polarizers are disposed on illumination sections of the light sources 200a and 200b in such a manner that each LED light includes a polarization component in a predetermined direction.

The configuration example of the display device 10 according to the present embodiment has been described above. Note that, the configuration described above with reference to FIG. 5 is a mere example. The configuration of the display device 10 according to the present embodiment is not limited thereto. As described above, the configuration of the display device 10 according to the present embodiment can be flexibly modified in accordance with specifications and operations.

### 2 Conclusion

As described above, the display board 100 according to an embodiment of the present disclosure includes the composite region 130 that includes a portion provided with the metal film and a potion provided with no metal film. In addition, one of features of the composite region 130 is that the portion provided with the metal film or the portion provided with no metal film has a predetermined dispersion pattern. Such a configuration makes it possible to switch display while reducing a difference in luminance between the regions more.

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

In addition, the effects described herein are illustrative or exemplary but not limitative. That is, besides the above effects or instead of the above effects, the technology according to the present disclosure may provide other effects that are obvious to a person skilled in the art.

### REFERENCE SIGNS LIST

10 display device
100 display board
110 first region
120 second region
130 composite region
140 light shielding region
200a, 200b light source

1. A display board comprising
a composite region that includes a portion provided with a metal film and a potion provided with no metal film,
wherein the portion provided with the metal film or the portion provided with no metal film has a predetermined dispersion pattern.

2. The display board according to claim 1,
wherein the portion provided with the metal film is positioned on a tip of a pillar structure, and the pillar structure has a dot-like shape.

3. The display board according to claim 2,
wherein the composite region includes a plurality of small regions including the pillar structures of different formation patterns.

4. The display board according to claim 2,
wherein the pillar structure has a size capable of absorbing wavelength of a visible light region.

5. The display board according to claim 1, further comprising:
a first region that includes the metal film that is striped in a first direction;
a second region that includes the metal film that is striped in a second direction, which is perpendicular to the first direction; and
a light shielding region that has a surface entirely covered with the metal film.

6. A display device comprising:
a display board including
a composite region that includes a portion provided with a metal film and a potion provided with no metal film, the portion provided with the metal film or the portion provided with no metal film having a predetermined dispersion pattern; and
a light source that emits illumination light toward the display board.
